(19) United States
(12) Patent Application Publication
(10) Pub. No.: US 2017/0068981 A1
(43) Pub. Date: Mar. 9, 2017

(54) SYSTEM AND METHOD OF PROVIDING PERPETUAL ELECTRONIC COUPON

(71) Applicant: SavvyPhone, LLC, St. Petersburg, FL (US)

(72) Inventors: David Etheredge, Clearwater, FL (US); Daud Power, St. Petersburg, FL (US)

(21) Appl. No.: 14/846,372

(22) Filed: Sep. 4, 2015

(51) Int. Cl. G06Q 30/02

(52) U.S. Cl. CPC G06Q 30/0222; G06Q 30/0225; G06Q 30/0235

(57) ABSTRACT

A system and method for providing coupons to an account, are provided. The method includes: first providing an electronic first coupon to the account for redemption at a store; executing, in response redemption of the coupon, a transaction with the first coupon; voiding the first coupon, in response to a selection at a store to replace the first coupon, without applying the first coupon to a transaction; imposing, in response to the executing and voiding, a waiting period during which time the account cannot receive a new coupon to replace the first coupon; and second providing, after elapse of the waiting period, a second coupon to the account to replace the first coupon; wherein the subject matter of the first coupon is different from the subject matter of the second coupon.

### CROSS REFERENCE TO RELATED APPLICATIONS

The instant application claims priority to U.S. Provisional Patent application 62/047,186 filed Sep. 8, 2014 and entitled SYSTEM AND METHOD OF PROVIDING PERPETUAL ELECTRONIC COUPON, the contents of which are incorporated herein by reference.

### FIELD OF THE INVENTION

The various embodiments described herein relate generally to a perpetual electronic coupon. More specifically, the present invention relates to a method for a store to distribute special offers to individual customers to provide continuous incentive for the customer to visit the store.

### BACKGROUND

Retail institutions that provide goods (physical or intangible, such as digital items) and/or services—whether through physical retail locations and/or web services (individually and collectively “stores”)—rely heavily on foot traffic (in person at a retail location or virtual visits to the website) to the stores to sell goods. The more traffic driven to the store, the higher the store's prospective sales.

To facilitate foot traffic, it is well known for a store to provide coupons, special offers and/or incentives (individually and collectively “coupon”) to entice individual customers to shop at the store, e.g., 50% off a certain item, buy one get one free, etc. Such offers may be made to the general public (e.g., general advertisements or coupon circulations in the Sunday papers) or to a target group (e.g., members of an email mailing list). Even though the discount of the coupon often generates a net loss to the store on the particular subject item of the coupon, the customer will often buy other items during the visit that are not similarly discounted. The underlying business plan is that corollary sales from the additional foot traffic generated by the coupon offsets (and hopefully supersedes) the loss from the coupon itself, thus making the coupon a driver of net sales gain.

A drawback with typical coupons is that the coupon is useless if the customer is not interested in the particular subject of the offer. For example, if the coupon is for “buy one shirt and get a second one free”, the offer is not appealing to a customer who does not need shirts; the coupon therefore fails to generate additional foot traffic with that customer.

Often a store will issue a coupon to the customer as part of the checkout process; a typical example is that supermarkets often print coupons on the back of the issued receipt at the cashier. The intent is to entice return foot traffic to the store. These coupons suffer from the same drawback as above, in that the customer may not be interested in the subject of the coupon. Since the coupon is part of a receipt, the customer is more likely to lose or misplace it. The customer can also simply turn around into the store and buy the product subject to the coupon; this keeps the customer in the store longer but is not an independent foot traffic event that tends to drive additional purchases (as the customer has already purchased what they wanted for the first checkout). This circumstance may result in a net loss because the store takes the loss on the coupon without the upside of offsetting corollary sales.

### BRIEF DESCRIPTION OF THE DRAWINGS

Various embodiments in accordance with the present disclosure will be described with reference to the drawings, in which:

FIG. 1 illustrates a flowchart of an embodiment of the invention.

FIG. 2 illustrates a signal management flow of an embodiment of the invention.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

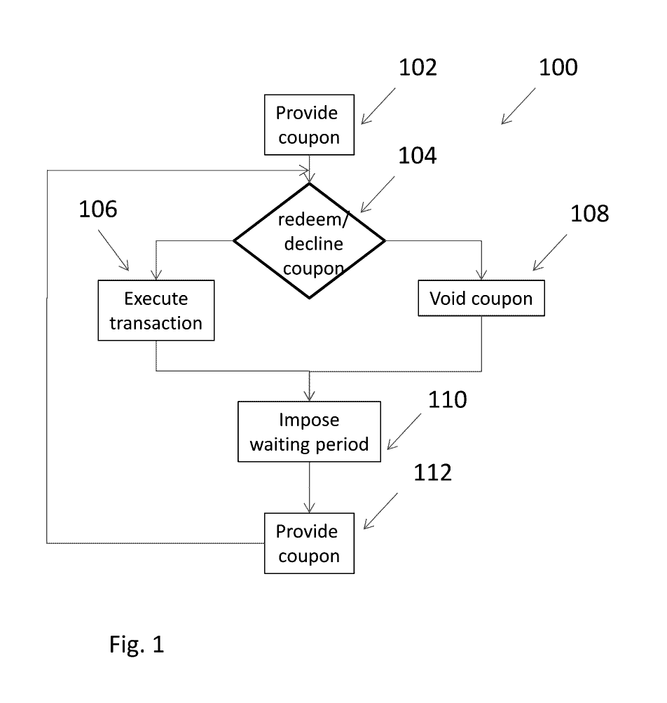

Referring now to FIG. 1, a flow chart of coupon distribution and use for a particular account of a customer is shown generally at 100. At 102 a store provides a customer with a coupon for future use. Preferably the coupon is provided electronically such as via email, SMS, or a link to the coupon (the link is considered herein electronic provision of the coupon even though the customer may have to take further action to access the actual coupon), but the invention is not so limited. Preferably the coupon is directed to a particular customer (e.g., unique to the customer, targeted to the customer based on preexisting criteria or past shopping habits, or sent to a global mailing group), but the coupon may be a public mass distribution or general advertisement. Preferably the coupon is provided by the store, although it may be provided by a third party operating at the store's request; for ease of discussion the examples herein are limited to the store acting alone, although it is to be understood that the invention is not so limited.

At 104 the store provides the customer with the option to redeem the coupon at an authorized store location. Preferably this option may be presented physically at a retail outlet and/or virtually at the store's website, although dependent upon the coupon it may limited to one type of store or store location. If the customer elects to redeem the coupon at step 104, the store accepts the redemption of the coupon and process the corresponding sale at 106. By way of non-limiting example, the store may scan the coupon, or enter a code from the coupon, and ring the transaction up at a register. The methodology for applying a coupon to a transaction is well known and not discussed further herein.

The store also at 104 provides the customer with the option of selecting to decline the coupon in favor of a replacement coupon; this option may be used for example when the current coupon is not of interest to the customer. If the customer elects to replace the coupon at 104, then the system voids the coupon at 108, and it is no longer useable.

Following the transaction at 106 or the void at 108, control passes to 110 where a predetermined waiting period is initiated; this may be a timer for a predetermined duration (e.g., 24 hours) or a predetermined elapse time (e.g., noon of the following day). The waiting period may be of any desired length, but preferably is at least 24 hours. The waiting period is preferably the same regardless of whether triggered by the transaction at 106 or the void at 108, but this need not necessarily be the case and there could be a different waiting period based on whether the coupon was redeemed at 106 or voided at 108. The waiting period may be specific to the particular customer, or common to a group of customers (e.g., noon tomorrow for all customers who redeemed today).

Once the waiting period of 110 elapses, a new/replacement coupon becomes available to the customer at 112. Preferably, the subject matter of the coupon (e.g., the goods covered, the nature of the offer) has changed in some way, although this need not be the case. The system can automatically send the new/replacement coupon to the customer, or wait for the customer to affirmatively contact the system to request the new/replacement coupon. Preferably the coupon is provided electronically via the same methodology as prior coupons, such as via email, SMS, or a link, but the invention is not so limited. The customer can then elect to redeem or replace the coupon at 104, whereupon the process of flowchart 100 repeats to continually provide the customer with new coupons.

The above embodiment has several advantages over the prior art. By providing an option at 104 for the customer to decline the coupon at the store the customer is incentivized to visit the store even if the subject matter of the initial coupon itself is not appealing. A store visit to decline the coupon is an independent foot traffic event that may lead to other sales—without the loss typically incurred by transaction of the coupon. The waiting period at 110 also ensures that the user must return at a later time to redeem/void the coupon, thus generating a potential follow on visit that is an independent foot traffic event, and at a sufficient time distant that the customer's needs may have changed relative to the last visit.

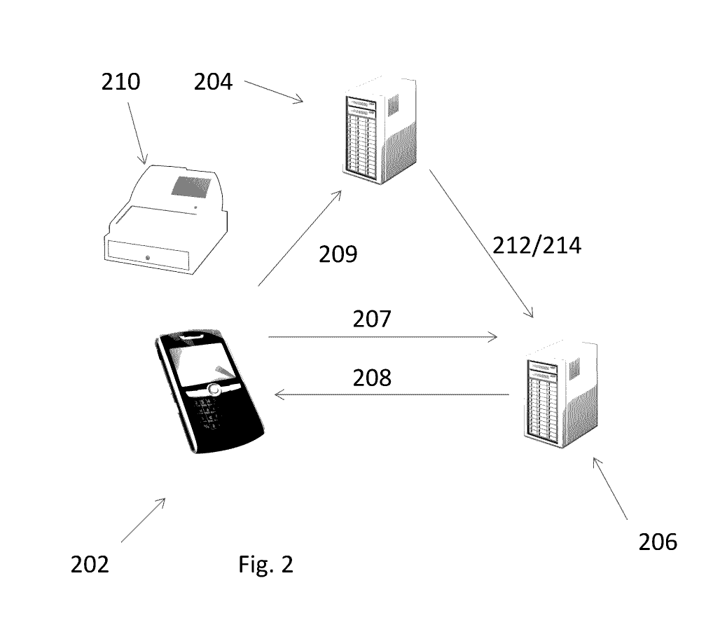

Referring now to FIG. 2, the above embodiment is now described in a non-limiting example of supporting architecture. The primary components of the architecture is a customer's electronic device 202 (e.g., a computer, smart phone, etc.), a server 204 maintained by the store, referred to herein as the store server 204, a server 206 maintained for coupon circulation, referred to herein as coupon server 206, and for a physical retail location a point of sale interface 210. While servers 204 and 206 are shown as distinct components, they may in fact be a common component. Each server may also be made of individual and/or dispersed server components or other computer components.

The customer's device 202 preferably has access to a web application or web page to receive and manipulate internet content relating to the receipt and distribution of coupons. The app may be, by way of non-limiting example, a local micro-site electronic card as shown in U.S. Ser. No. 13/666,927 entitled SYSTEM AND METHOD FOR ADAPTIVE ELECTRONIC DISTRIBUTION OF INFORMATION, the contents of which are expressly incorporated herein by reference in its entirety. A button on that card may bring up a prompt with a web link to the coupon. The customer at 102 selects the link, sending an appropriate coupon request signal/message 207 to coupon server 206 (either directly or routed through store server 204 and/or other intermediate equipment). Coupon server 206 responds to the request with the information of the coupon 208 in a format that can render on the customer device 202 (or other device as may be used to access the customer's account).

Customer device 202 receives the information for the coupon 208 and displays/renders the received coupon 208 on the screen of the customer device 202. The arrival and/or rendering may be accompanied by visual and/or audio theatrics to enhance the appeal of the coupon.

The coupon 208 may have an expiration date. The coupon is thus perpetual until it is expires from non-use, or is otherwise redeemed/replaced at 106/108. If the coupon 208 expires, then the customer may obtain a new coupon per 102 above.

For an unexpired coupon 208 (including one with no expiration date), the user preferably cannot use the web application alone to obtain redeem or replace new coupon 208. Rather, at 104 the customer can visit the store, either physically or virtually, and either redeem the coupon 208 at 106 or request a replacement at 108. This visit creates an independent foot traffic event that can lead to corollary sales that are not specifically related to the coupon 208.

By way of non-limiting example, when the unexpired coupon is pending and the customer wants a new coupon, the web app may simply not provide a link or button for the customer to request a new coupon. In another non-limiting example, a button or link may be provided which sends a message to store server 204 and/or coupon server 206, for which the reply may be an indication of how a new coupon may be obtained (e.g., wait for the expiration, redeem coupon or decline coupon at the store). In another non-limiting example, the customer could request the coupon server 206 to automatically send a new coupon when the current one expires.

If the customer redeems the coupon 208 at 104, then the store will process the transaction at 106 and dispatch a corresponding signal 209 (originating either from customer's device 202 for a web site visit, a point of sale interface 210 or the customer's device 202 if at a retail location); the details of the execution of such transaction are well known in the art and not described further herein. In response to execution of the transaction at 106, coupon server 206 receives a message 212 informing it that the coupon 208 has been redeemed. The alert may come from any of several sources, including the customer device 202 (which may need authorization of some type from the store), the store server 204 (as shown in FIG. 2), and/or the point of sale interface 210 at which the coupon was used, etc. Coupon server 206 may also engage in further communications with any of those components to confirm that the transaction has in fact taken place. The methodologies for redeeming a coupon in this manner are known in the art and not set forth herein.

If the customer elects at 104 to decline the coupon 208 in favor of a replacement, then coupon server 206 receives a message 214 informing it that the coupon 208 has been declined. The alert may come from any of several sources, including the customer device 202 (which may need authorization of some type from the store), the store server 204 (as in FIG. 2), point of sale interface 210, etc. Coupon server 206 may also engage in further communications with any of those components to confirm that the coupon has in fact been declined. Message 212 and 214 may contain the same content/message indicating the generic exercise of the coupon 208, or may specifically identify whether the use was redemption or replacement request.

Once the coupon 208 is redeemed or declined, the particular customer's account is placed into a waiting period as discussed above at 110. This period could be transparent to the customer, in that no specific indication is given of the waiting period (unless a new coupon is requested prematurely, which would be declined by coupon server 206 as discussed above). In the alternative, the customer could be informed periodically or in real time of the amount of time remaining in the waiting period. By way of non-limiting example, the web app may display a countdown timer of when a new coupon will be available.

In the above embodiment, the customer preferably can only receive a single coupon 208 at a time from the store. In an alternative embodiment, the user may have multiple coupon slots associated with the user's account. Thus by way of non-limiting example, the customer may have three slots, and can receive three coupons. Each slot may operate independently according to an embodiment of the invention. Thus for example a user could request two coupons, one might not be used within its expiration period while the other is declined to create a waiting period; the user could then request a third coupon for the third slot, even though a new coupon is not yet available for the first two slots. One of the slots may operate in accordance with the embodiments herein, while other slots may operate on different methodologies.

In yet another embodiment, the individual slots may be dedicated to particular classes of goods or services, e.g., one slot for a clothing offer, a second slot for a home goods offer, and a third slot for an appliance offer. Each slot could operate independently, or be related (e.g., redeem two coupon slots to open a third slot).

Customers could have the same or different amount of slots. For example, customers in a frequent shopper program may receive additional permanent or temporary slots when they hit certain milestones. In another embodiment, such milestones could be used to change the length of the waiting time between coupons.

The various components shown in FIG. 2 and as otherwise might be used in the embodiments herein include general purpose or specialized computing devices, such as desktop or laptop computers, or mainframe computers, as well as cellular, wireless, and handheld devices running mobile software and capable of supporting a number of networking and messaging protocols. The code coverage testing can be performed in a distributed system including any number of workstations running any of a variety of commercially-available operating systems and other known applications for purposes such as development and database management. These devices also can include other electronic devices, such as dummy terminals, thin-clients, gaming systems, and other devices capable of communicating via a network.

Embodiments may utilize at least one network that would be familiar to those skilled in the art for supporting communications using any of a variety of commercially-available protocols, such as TCP/IP, FTP, SFTP, UPnP, NFS and CIFS. The network can be, for example, a local area network, a wide-area network, a virtual private network, the Internet, an intranet, an extranet, a public switched telephone network, an infrared network, a wireless network, and any combination thereof.

In embodiments where the computing device includes a Web server, the Web server can run any of a variety of server or mid-tier applications, including HTTP servers, FTP servers, CGI servers, data servers, Java® servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The above embodiments may operate concurrently with other coupon methodologies. For example, the store may continue to independently provide coupons via email or paper, such coupons preferably not influencing the processing for coupon 208.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for providing coupons to an account, comprising:
first providing an electronic first coupon to the account for redemption at a store;
executing, in response redemption of the coupon, a transaction with the first coupon;
voiding the first coupon, in response to a selection at a store to replace the first coupon, without applying the first coupon to a transaction;
imposing, in response to the executing or voiding, a waiting period during which time the account cannot receive a new coupon to replace the first coupon; and
second providing, after elapse of the waiting period, a second coupon to the account to replace the first coupon;
wherein the subject matter of the first coupon is different from the subject matter of the second coupon.

2. The method of claim 1, wherein the first coupon has an expiration date, and wherein the executing and voiding can only be exercised for the first coupon before elapse of the expiration date.

3. The method of claim 1, further comprising preventing the account from receiving a new coupon to replace the first coupon before either the executing or voiding is performed.

4. The method of claim 3, wherein the first coupon has an expiration period, and wherein the executing and voiding can only be exercised for the first coupon within the expiration period.

5. The method of claim 1, wherein the waiting period imposed is different based upon whether the executing or voiding is selected.

6. The method of claim 1, further comprising reducing the waiting period imposed when the account reflects a predetermined amount of activity associated with the account.

7. The method of claim 1, wherein the executing is in response to an indicia received from the store that the coupon has been redeemed.

8. The method of claim 1, wherein the voiding is in response to an indicia received from the store that the coupon is to be replaced.

9. The method of claim 1, wherein the second providing is responsive to elapse of the waiting period.

10. The method of claim 1, wherein the second providing is responsive to a request received after the waiting period for the second coupon.

11. A method for providing coupons to an account having a plurality of coupon slots, comprising, for each slot:
first providing an electronic first coupon to the account for redemption at a store;
executing, in response redemption of the coupon, a transaction with the first coupon;
voiding the first coupon, in response to a selection at a store to replace the first coupon, without applying the first coupon to a transaction;
imposing, in response to the executing and voiding, a waiting period during which time the account cannot receive a new coupon to replace the first coupon; and
second providing, after elapse of the waiting period, a second coupon to the account to replace the first coupon;
wherein the subject matter of the first coupon is different from the subject matter of the second coupon.

12. The method of claim 11, wherein the method is performed independently for each slot of the account.

13. The method of claim 11, further comprising preventing a particular slot of the account from receiving a new coupon to replace the first coupon before either the executing or voiding is performed for that slot.

14. The method of claim 13, wherein the first coupon has an expiration period, and wherein the executing and voiding can only be exercised for the first coupon within the expiration period.

15. The method of claim 11, wherein the waiting period imposed is different based upon whether the executing or voiding is selected.

16. The method of claim 11, further comprising reducing the waiting period imposed when the account reflects a predetermined amount of activity associated with the account.

17. The method of claim 11, wherein the executing is in response to an indicia received from the store that the coupon has been redeemed.

18. The method of claim 11, wherein the voiding is in response to an indicia received from the store that the coupon is to be replaced.

19. The method of claim 11, wherein the second providing is responsive to elapse of the waiting period.

20. The method of claim 11, wherein the second providing is responsive to a request received after the waiting period for the second coupon.
